(19) United States
(12) Patent Application Publication
(10) Pub. No.: US 2026/0120127 A1
(43) Pub. Date: Apr. 30, 2026

(54) CONSUMER INNER TENDENCY TYPING ANALYSIS MODEL PRODUCTION SYSTEM AND METHOD USING GENERATIVE AI

(71) Applicant: SALTMINE, INC., Hanam-si (KR)

(72) Inventor: Chang Hyun YOO, Hanam-si (KR)

(73) Assignee: SALTMINE, INC., Hanam-si (KR)

(21) Appl. No.: 19/433,093

(22) Filed: Dec. 26, 2025

Related U.S. Application Data
(63) Continuation of application No. PCT/KR2024/010447, filed on Jul. 19, 2024.

(30) Foreign Application Priority Data
Jun. 20, 2024 (KR) 10-2024-0080298

(51) Int. Cl. G06Q 30/0201

(52) U.S. Cl. CPC G06Q 30/0201

(57) ABSTRACT

The present invention relates to a consumer inner tendency typing analysis model production system and method using generative AI, and the present invention can automatically produce a consumer typing module that can classify consumer's inner tendencies into 256 types based on four tendency topics simply by inputting a client company's topic. Through this consumer typing module, the client company can provide customized customer services and customized marketing strategies for each consumer type, along with product recommendations and personalized services.

### CROSS REFERENCE TO PRIOR APPLICATIONS

This application is a continuation application of PCT International Patent Application No. PCT/KR2024/010447 filed on July 19, 2024, which claims priority to Korean Patent Application No. 10-2024-0080298 filed on June 20, 2024 which are all hereby incorporated by reference in their entirety.

### BACKGROUND

The present invention relates to a consumer inner tendency typing analysis model production system and method using generative AI and, more specifically, to a consumer inner tendency typing analysis model production system and method using generative AI, capable of automatically generating a customized consumer typing module for analyzing and typing an inner tendency of a consumer even when only a topic suitable for a consumer of a company is input.

Companies want to accurately identify consumers' needs and establish customized strategies to differentiate services and secure a competitive advantage in the market. In particular, it is essential to meet various needs and expectations of consumers in the midst of rapid change and competition in the digital age. Existing big data analysis is useful in identifying general consumer trends and patterns from vast amounts of data. Through this, companies may establish large-scale marketing strategies, but it has limitations in deeply understanding the inner tendencies and psychological characteristics of individual consumers. Since big data mainly focuses on deriving the characteristics of large groups through statistical correlations, it lacks a personalized approach.

Small data is more useful for identifying and understanding an individual's inner tendencies, tastes, preferences, and psychological characteristics. Small data focuses on identifying who the consumer is by providing data from the perspective of human literacy. For example, big data tells us that "many people buy certain products," but small data allows us to understand "why certain consumers have purchased these products." This is useful for deriving individual characteristics through causal relationships in data. Through small data, consumers' inner tendencies can be analyzed and personalized needs can be analyzed.

Consumer inner tendency typing model production technology is an effective tool for analyzing and typing consumers' inner tendency, but it requires specialized personnel and has the following problems.

First, the small data model is vulnerable to data shortage problems. In particular, data related to the extraction of consumers' inner tendency is difficult to collect and is often insufficient. Data shortage may lead to reduced model learning performance and reduced typing accuracy.

In addition, it makes the model training and improvement process complex and time-consuming. Training models with small data requires significant time and effort, and model improvement also requires iterative work. Difficulties in model training and improvement may lead to increased costs and reduced development efficiency.

In addition, the involvement of small data experts is absolutely required to develop customized data models based on consumer small data. Consumer inner tendencies appear differently for each individual depending on the topic, and thus the existing small data model may not be able to sufficiently reflect individual differences. This leads to limitations in marketing and customer experience delivery.

Patents related to consumer typing include the following.

Korean patent registration No. 10-1355832 relates to an automatic generation database for customer information, in which when an advertiser inputs information purchased by a customer online to a system, a consumer information typing program of the system automatically types or segments the customer based on data such as information on a day on which the customer purchases or visits, purchase motivation, purchase pattern, and the like.

It relates to a customized direct advertising system, in which. the consumer information typing program is a program in which items considered to affect purchase such as weather, day of the week, anniversary, purchase motivation, repurchase period, and the like are set, and thus the customer is customized and typed(or segmented) for each customer, and when a situation similar to the purchase motivation and pattern of a specific customer occurs, the advertisement is transmitted only to the corresponding customer.

Korean patent laid-open publication No. 10-2022-0137233 relates to a product recommendation system based on personal information, which performs statistical analysis using personal information and purchase history of a plurality of customers to generate various types of customer groups and product groups belonging thereto, and, when a product recommendation request is received from a user terminal device, acquires a customer group matching user personal information of the user terminal device and outputs recommended product information. Korean patent laid-open publication No. 10-2022-0137233 classifies and accumulates the personal information and purchase history of a plurality of customers according to various criteria and recommends a product to a customer having similar personal information, thereby providing product information suitable for the lifestyle of the customer.

Korean patent registration No. 10-1355832 performs typing based on the purchase season, purchase date, purchase day of the week, purchase week, whether purchased after advertisement, repurchase period, purchased product, and the like, rather than performing typing based on their inner tendencies, and thus there is a problem in that it is difficult to accurately analyze the consumer's needs.

Korean patent laid-open publication No. 10-2022-0137233 recommends a product based on personal information, wherein the personal information refers to age, gender, occupation, hobbies, marital status, and the like. Personal information-based customer analysis is suitable for big data analysis, but has a problem in that the accuracy of small data analysis is poor.

Therefore, there is an urgent need to introduce a system that can analyze the internal tendencies of client company's consumers regardless of the client company's data shortage, minimize the client company's cost burden by investing less time in producing a consumer internal tendency typing analysis model, and produce the model in customized manner for each of various topics of the client company.

### SUMMARY

The present invention has been made in order to improve the above-described problems, and is intended to provide a consumer inner tendency typing analysis model production system using generative AI, capable of automatically generating a customized consumer typing module for analyzing and typing an inner tendency of a consumer even when only a topic suitable for a consumer of a client company is input.

The present invention is intended to provide a consumer inner tendency typing analysis model production system using generative AI, capable of accurately classifying consumer types of a client company by classifying consumers of the client company into 256 types based on four tendency topics of relationship attitude, way of thinking, decision-making, and lifestyle.

The present invention is intended to provide a consumer inner tendency typing analysis model production system using generative AI, capable of producing a customized model suitable for various consumers of a company by generating a final typing module composed of a set of questions and answers for classifying consumer types according to tendency topics by using the generative AI.

The present invention has been made in order to improve the above-described problems, and is intended to provide a consumer inner tendency typing analysis model production system using generative AI, capable of automatically generating a customized consumer typing module for analyzing and typing an inner tendency of a consumer even when only a topic suitable for a consumer of a client company is input.

The present invention is intended to provide a consumer inner tendency typing analysis model production system using generative AI, capable of accurately classifying consumer types of a client company by classifying consumers of the client company into 256 types based on four tendency topics of relationship attitude, way of thinking, decision-making, and lifestyle.

The present invention is intended to provide a consumer inner tendency typing analysis model production system using generative AI, capable of producing a customized model suitable for various consumers of a company by generating a final typing module composed of a set of questions and answers for classifying consumer types according to tendency topics by using the generative AI.

According to the present invention having the configuration as described above, the following effects are achieved.

When only a topic of a typing model suitable for a consumer of a client company is input, a prompt is optimized, data is automatically collected through the optimized prompt, and the collected data is coupled with a typing model that types consumers into 256 types based on four tendency topics of relationship attitude, way of thinking, decision-making, and lifestyle and applied to a generative AI, thereby automatically and quickly generating a customized consumer typing module suitable for the client company.

The customized consumer typing module ultimately provided to the client company can analyze individual's inner tendencies more accurately and in-depth, and type or segment them into a total of 256 types for each consumer's characteristics, enabling customized services for each customer type.

Companies can more effectively understand their customers through consumer tendency analysis and typing based on small data, and based on this, they can improve services and products, and establish and implement customized marketing strategies for each consumer type, thereby increasing customer loyalty.

In addition, by using small data rather than big data-based, companies can reduce costs.

### BRIEF DESCRIPTION OF THE DRAWINGS

FIG. 1 is a functional block diagram of a consumer inner tendency typing analysis model production system using generative AI according to the present invention.

FIG. 2 is a detailed functional block diagram of a basic typing module.

FIG. 3 is a structural diagram of a primary indicator and a secondary indicator for four tendency topics.

FIG. 4 is a conceptual diagram of a typing module algorithm for classifying consumers into a total of 256 types based on four tendency topics.

FIG. 5 is a flowchart of a consumer inner tendency typing analysis model production system method using generative AI.

### DETAILED DESCRIPTION OF THE INVENTION

In order to achieve the above objects, a consumer inner tendency typing analysis model production system using generative AI according to the present invention is configured to include a consumer typing topic input unit that inputs a topic of a typing model suitable for a consumer of a client company, a small data coupling unit that collects and preprocesses data corresponding to the inputted topic of the typing model, and couples the data with a typing model that classifies inner tendency of the consumer for the topic of the typing model according to types based on four tendency topics of relationship attitude, way of thinking, decision-making, and lifestyle to prepare for input into a generative AI, a type data generation unit that generates and verifies a text and image set for consumer type classification by applying the data received from the small data coupling unit to the generative AI, and a customized consumer typing model generation unit that generates a final typing module composed of a question and answer set for classifying the inner tendency of the consumer corresponding to the inputted topic according to the four tendency topics of relationship attitude, way of thinking, decision-making, and lifestyle using the verified text and image set.

The small data coupling unit includes prompt optimization module that generates a prompt associated with the four tendency topics of relationship attitude, way of thinking, decision-making, and lifestyle capable of identifying the inner tendency of the consumer for the inputted topic, a data preprocessing module that collects data using the prompt generated by the prompt optimization module and performs tagging and labeling on the collected data, a basic typing module that couples the tagged, labeled data with a typing module for classifying the inner tendency of the consumer into 256 types according to types based on the four tendency topics of relationship attitude, way of thinking, decision-making, and lifestyle, and an encoding/token conversion module that processes LLM encoding and token conversion for communication with the generative AI.

In addition, the prompt optimization module may be applied with a method of analyzing topics and prompt patterns of an existing generated prompt database using an artificial intelligence neural network-based algorithm and automatically generating a prompt suitable for the input topic.

The basic typing module is characterized by classifying tagged, labeled data are into up to 16 types according to a primary indicator based on the four tendency topics of the relationship attitude, way of thinking, decision-making, and lifestyle, and further classifying the tagged, labeled data into up to 16 types according to a secondary indicator to thereby classify a consumer group into a total of 256 types.

Specifically, the basic typing module may be configured to include a primary indicator module that types consumer tendency into two primary indicators for each tendency topic for the four tendency topics, a secondary indicator module that types the primary indicator into two secondary indicators according to the consumer tendency, a primary indicator determination module that determines the primary indicator for each of the four tendency topics by substituting the data tagged and labeled by the data preprocessing module into the primary indicator module, a secondary indicator determination module that determines the secondary indicator for each of the four tendency topics by substituting the data tagged and labeled by the data preprocessing module into the secondary indicator module, and a basic typing result output module that outputs a basic typing result by reflecting the determinations of the primary indicator and the secondary indicator.

The basic typing module may further include a primary indicator learning module that trains the primary indicator for each of the four tendency topics by applying tagged and labeled training data to a supervised learning-based machine learning engine, and a secondary indicator learning module that trains the secondary indicator for each of the four tendency topics by applying the tagged and labeled training data and the primary indicator to the supervised learning-based machine learning engine, and the primary indicator determination module may be configured to determine the primary indicator for each of the four tendency topics by applying the data tagged and labeled by the data preprocessing module to the primary indicator learning module, and the secondary indicator determination module may be configured to determine the secondary indicator for each of the four tendency topics by applying the data tagged and labeled by the data preprocessing module and the primary indicator determined by the primary indicator determination module to the secondary indicator learning module.

The type data generation unit is configured to include a generative AI application module that applies data received from the small data coupling unit to the generative AI to expand a dataset of a typing module by additionally generating or modifying text and images for classifying the inner tendency of the customer into a total of 256 types according to types based on the four tendency topics of relationship attitude, way of thinking, decision-making, and lifestyle, a natural language processing module that removes noise of the text generated through a generative AI application module, an image classification module that classifies an appropriate image among images generated through the generative AI application module, and a data verification module that verifies the text from which the noise is removed and the classified image.

The generative type AI application module is characterized by applying the data received from the small data coupling unit to the generative AI to generate a plurality of questions for determining a primary indicator and a plurality of answers matched for each primary indicator for each of four tendency topics of relationship attitude, way of thinking, decision-making, and lifestyle, and generate a plurality of questions for determining a secondary indicator and a plurality of answers matched for each secondary indicator.

The customized consumer typing module generation unit generates a final typing module, which classifies consumers into 256 types by generating a single question for determining a primary indicator and an answer matched for each primary indicator and generating a plurality of questions for a secondary question and an answer matched for each secondary indicator for each of the four tendency topics of relationship attitude, way of thinking, decision-making, and lifestyle by using verified data received from the type data generation unit, and provides the final typing module to a client company.

The client company is provided with the final typing module and a survey UI for identifying the inner tendency of the consumer.

Meanwhile, in order to achieve the above object, a consumer inner tendency typing analysis model production method using generative AI according to the present invention is configured to include a first step of inputting a topic of a typing model suitable for a consumer of a client company, a second step of generating a prompt associated with the four tendency topics of relationship attitude, way of thinking, decision-making, and lifestyle capable of identifying the inner tendency of the consumer for the inputted topic, a third step of collecting data using the prompt generated by the prompt optimization module and performing tagging and labeling on the collected data, a fourth step of classifying tagged, labeled data into up to 16 types according to a primary indicator based on the four tendency topics of the relationship attitude, way of thinking, decision-making, and lifestyle, and further classifying the tagged, labeled data into up to 16 types according to a secondary indicator to basically classify a consumer group into a total of 256 types, a fifth step of processing LLM encoding and token conversion for communication with the generative AI, a sixth step of applying a received token to the generative AI to expand a dataset of a typing module by additionally generating or modifying text and images for classifying the inner tendency of the customer into a total of 256 types according to types based on the four tendency topics of relationship attitude, way of thinking, decision-making, and lifestyle, a seventh step of removing noise of the text generated through a generative AI, an eighth step of classifying an appropriate image among images generated through the generative AI, a ninth step of verifying the text from which the noise is removed and the classified image, and a tenth step of generating a final typing module, which classifies consumers into 256 types by generating a single question for determining a primary indicator and an answer matched for each primary indicator and generating a plurality of questions for a secondary question and an answer matched for each secondary indicator, for each of the four tendency topics of relationship attitude, way of thinking, decision-making, and lifestyle by using verified data

Specifically, in the fourth step, tagged, labeled data is applied to a primary indicator learning module to determine the primary indicator for each of the four tendency topics, and the tagged, labeled data and the primary indicator determined by the primary indicator determination module are applied to a secondary indicator learning module to determine a secondary indicator for each of the four tendency topics.

Advantages and features of the present invention, and methods of achieving the same will become apparent with reference to embodiments described below in detail with reference to the accompanying drawings.

However, the present invention is not limited to the embodiments disclosed below, and may be implemented in various different forms.

The embodiments in this specification are provided to make the disclosure of the present invention complete and to fully inform the scope of the invention to those skilled in the art to which the present invention belongs.

In addition, the present invention is only defined by the scope of the claims.

Therefore, in some embodiments, well-known components, well-known operations, and well-known techniques are not specifically described in order to avoid ambiguous interpretation of the present invention.

In addition, like reference numerals refer to like elements throughout the specification, and terms used (described) in the present specification are for describing the embodiments and are not intended to limit the present invention.

In the present specification, the singular forms include the plural forms unless otherwise specified in the phrases, and the components and operations referred to as “comprise (or include)” do not exclude the presence or addition of one or more other components and operations.

Unless otherwise defined, all terms (including technical and scientific terms) used herein may be used in the sense commonly understood by a person of ordinary skill in the art to which the present invention belongs.

In addition, terms defined in commonly used dictionaries are not to be interpreted ideally or excessively unless they are defined otherwise.

Hereinafter, exemplary embodiments of the present invention will be described with reference to the accompanying drawings.

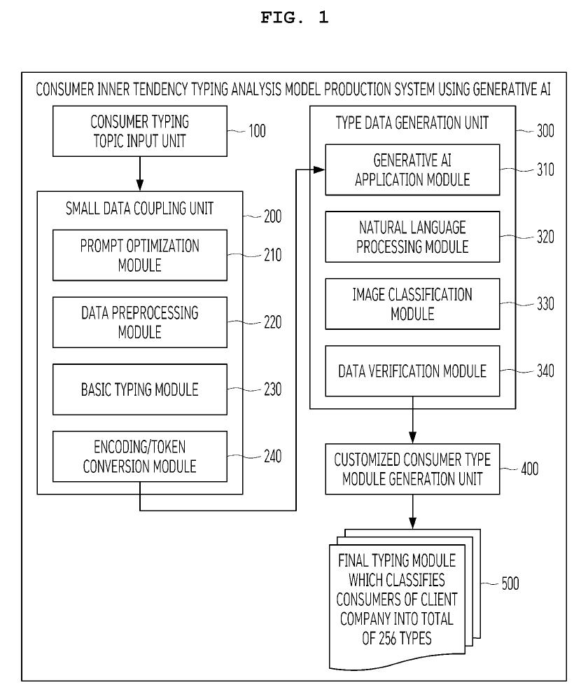

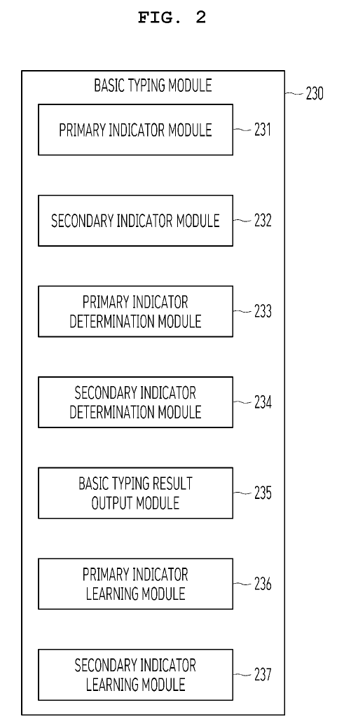

The present invention will be described in detail with reference to FIGS. 1 to 5.

[Consumer inner tendency typing analysis model production system using generative AI]

A consumer inner tendency typing analysis model production system using generative AI according to the present invention is configured to include a consumer typing topic input unit 100, a small data coupling unit 200, a type data generation unit 300, and a customized consumer type module generation unit 400.

The customized consumer typing module generation unit 400 generates a final typing module 500 that classifies consumers of a client company into a total of 256 types, generates a customer survey (text, image) applied to the final typing module 500 together, and provides the customer survey to the client company.

The consumer typing topic input unit 100 inputs the topic of a typing model suitable for the consumers of the client company. For example, topics such as interior design, investment, finance, consumption, learning, health, and food are input.

The small data coupling unit 200 collects and preprocesses data corresponding to the inputted topic of the typing model, and couples the data with a typing model that classifies inner tendency of the consumer for the topic of the typing model according to types based on four tendency topics of relationship attitude, way of thinking, decision-making, and lifestyle to prepare for input into generative AI.

The small data coupling unit 200 is configured to include a prompt optimization module 210, a data preprocessing module 220, a basic typing module 230, and an encoding/token conversion module 240.

The prompt optimization module 210 generates a prompt associated with the four tendency topics of relationship attitude, way of thinking, decision-making, and lifestyle capable of identifying the inner tendency of the consumer for the inputted topic.

For example, the prompt optimization module 210 may generate, for the topic "interior design", a prompt such as "I want to classify the consumer's inner tendencies regarding interior design based on four types of tendencies: relationship attitude, way of thinking, decision-making, and lifestyle. Please investigate the results according to various tendencies and tastes regarding interior design."

The prompt optimization module 210 may analyze a topic and a prompt pattern of an existing generated prompt database (not shown) using an artificial intelligence neural network-based algorithm, and automatically generate a prompt suitable for the input topic.

The prompt database stores various topics and prompts corresponding to the topics such as interior design, investment, finance, consumption, learning, health, and food.

The data preprocessing module 220 collects data in real time using various websites, databases, APIs, and the like using the prompt generated by the prompt optimization module 210, and tags and labels the collected data.

Examples of the data collected by the data preprocessing module 220 are as follows.

In case of the relation attitude tendency topic,

Independent type: Consumers of this type value personal space and prefer comfortable and practical interiors. They utilize simple, functional furniture and accessories to create a warm and comfortable atmosphere.

Social type: Consumers of this type value spaces shared with others and prefer flash, trendy interiors. They utilize various colors and patterns and use accessories that express their individuality.

Cooperative type: Consumers of this type value harmonious spaces and prefer soft, comfortable interiors. They utilize natural materials and warm colors to create a comfortable and cozy atmosphere.

In case of the way of thinking tendency topic,

Logical type: Consumers of this type value clear and rational spaces, and prefer simple and modern interiors. They utilize straight lines and geometric shapes to create a clean and sophisticated atmosphere.

Sensory type: Consumers of this type value sensual and beautiful spaces, and prefer elegant and sensual interiors. They utilize soft colors and natural materials to create emotional and atmospheric environments.

Creative type: Consumers of this type value unique and distinctive spaces and prefer unique and artistic interiors. They utilize various colors and patterns, and use accessories that express their individuality.

A user may designate a label to the collected data, or may use a tagging model trained using previously labeled data. In addition, the user may remove errors, missing values, unnecessary information, and the like are from the collected data.

The basic typing module 230 couples the tagged, labeled data with a typing module for classifying the inner tendency of the consumer into 256 types according to types based on the four tendency topics of relationship attitude, way of thinking, decision-making, and lifestyle.

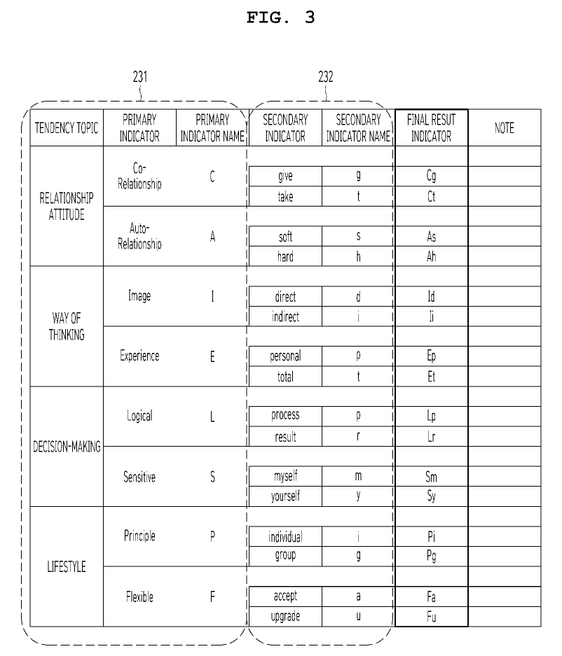

Referring to FIG. 3, the meaning of the primary indicator and the meaning of the secondary indicator for the four tendency topics are shown. Two primary indicators are included in each of the four tendency topics of the relationship attitude, way of thinking, decision-making, and lifestyle. When the primary indicator corresponding to the consumer's tendency is determined for the four tendency topics, a secondary indicator corresponding to the consumer's tendency among the two secondary indicators belonging to the primary indicator is determined and thereby a final result indicator is output.

When the final result indicators of Cg in the relationship attitude, Id in the way of thinking, Lp in the decision-making, and Pg in the lifestyle are output, the final typing result of the consumer becomes CgIdLpPg.

CgIdLpPg consumer type is described as below.

Cg: tendency to be influenced by others and tendency to help others

Id: tendency to be imaginative and tendency to think clearly and concisely

Lp: tendency to make rational determinations and value the process rather than the result

Pg: tendency to value principles and to like to get along with others.

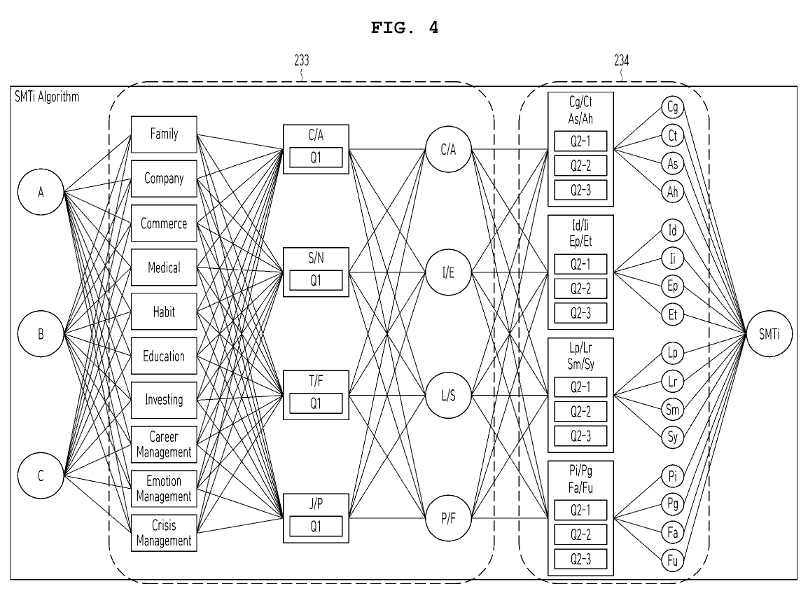

Referring to FIG. 4, the basic typing module 230 couples the data collected and tagged and labeled by the data preprocessing module 220 with a typing module algorithm that classifies consumers into a total of 256 types based on the four tendency topics and prepares for input into the generative AI model.

The data collected, tagged, and labeled by the data preprocessing module 220 may be insufficient to classify consumers into a total of 256 types based on the four tendency topics, and with reference to this, the generative AI expands the dataset to allow consumers to be classified into a total of 256 types.

The basic typing module 230 is coupled with a typing module for classifying the inner tendency of the consumer into 256 types based on the four tendency topics of relationship attitude, way of thinking, decision-making, and lifestyle, and prepares to match the tendency topic used in the typing module, the meaning of the primary indicator, the meaning of the secondary indicator, and the data collected by the data preprocessing module 220 with the primary indicator and the secondary indicator for each tendency topic and input these data into the generative AI model.

The typing module for classifying the inner tendency of the consumer into 256 types according to the types based on the four tendency topics includes a logic that determines, for each tendency topic, a primary indicator through a question and determines a secondary indicator belonging to the primary indicator through a question.

The encoding/token conversion module 240 processes LLM encoding and token conversion for communication with the generative AI. LLM encoding is a step required for the generative AI model to effectively process text data, and token conversion is to break down text data into tokens of individual words or sentences.

Referring to FIG. 3, the basic typing module 230 classifies tagged, labeled data into up to 16 types according to a primary indicator based on the four tendency topics of the relationship attitude, way of thinking, decision-making, and lifestyle, and further classifies the tagged, labeled data into up to 16 types according to a secondary indicator to classify a consumer group into a total of 256 types.

As for the primary indicator, a total of 16 cases are obtained by multiplying two relationship attitudes, two ways of thinking, two decision-making, and two lifestyles, and a total of 256 types of consumer groups can be classified by multiplying 16 primary indicators by 16 secondary indicators.

The basic typing module 230 includes a primary indicator module 231, a secondary indicator module 232, a primary indicator determination module 233, a secondary indicator determination module 234, and a basic typing result output module 235.

The primary indicator module 231 types the consumer's tendency into two primary indicators for each tendency topic for the four tendency topics.

The secondary indicator module 232 types the primary indicator into two secondary indicators according to the consumer's tendency.

The primary indicator determination module 233 determines the primary indicator for each of the four tendency topics by substituting the data tagged and labeled by the data preprocessing module 220 into the primary indicator module 231.

The secondary indicator determination module 234 determines the secondary indicator for each of the four tendency topics by substituting the data tagged and labeled by the data preprocessing module 220 into the secondary indicator module 232.

The basic typing result output module 235 outputs the basic typing result by reflecting the determinations of the primary indicator and secondary indicator. It performs basic typing work by determining the primary indicator and secondary indicator for data collected based on prompts, tagged, and labeled.

The basic type module 230 may include a primary indicator learning module 236 and a secondary indicator learning module 237.

The primary indicator learning module 236 trains the primary indicator for each of the four tendency topics by applying tagged and labeled training data to a supervised learning-based machine learning engine.

The secondary indicator learning module 237 trains the secondary indicator for each of the four tendency topics by applying the tagged and labeled training data and the primary indicator to the supervised learning-based machine learning engine.

The primary indicator determination module 233 determines the primary indicator for each of the four tendency topics by applying the data tagged and labeled by the data preprocessing module 220 to the primary indicator learning module 236.

The secondary indicator determination module 234 determines the secondary indicator for each of the four tendency topics by applying the data tagged and labeled by the data preprocessing module 220 and the primary indicator determined by the primary indicator determination module 233 to the secondary indicator learning module 237.

For example, in the case where the data tagged and labeled by the data preprocessing module 220 corresponds to "A consumer values personal space and prefers a comfortable and practical interior. Simple and functional furniture and props are utilized, and a warm and comfortable atmosphere is created.", the primary indicator determination module 233 may apply the data to the primary indicator learning module 236 to determine the primary indicator as A in the case of the tendency topic of relationship attitude and the secondary indicator determination module 234 may be apply the data to the secondary indicator learning module 237 to determine the secondary indicator as s in the case of the tendency topic of relationship attitude.

The type data generation unit 300 generates and verifies a text and image set for consumer type classification by applying the data received from the small data coupling unit 200 to the generative AI. The generative AI refers to a large language model (LLM) such as ChatGPT. In addition, the text and image set for consumer type classification refers to the content included in the survey to classify consumers of customers of the client company into 256 types.

The type data generation unit 300 includes a generative AI application module 310, a natural language processing module 320, an image classification module 330, and a data verification module 34.

The generative AI application module 310 applies the data received from the small data coupling unit 200 to the generative AI to expand the dataset of the typing module by additionally generating or modifying text and images for classifying the inner tendency of the customer according to types into 256 types based on the four tendency topics of relationship attitude, way of thinking, decision-making, and lifestyle.

In addition, the generated data is verified using the accuracy and F1 score for the generated text and image. Accuracy is to evaluate how much the generated text and image match the actual data, and the F1 score evaluates the quality of the generated data using an indicator considering accuracy and reproducibility.

Relationship attitude is to ask about the tendency to form and maintain relationships with others, and the way of thinking is to ask about problem solving and decision-making methods. Decision-making is to ask about the process of collecting, analyzing, judging, and selecting information, and lifestyle is to ask about the values and behavioral methods shown in everyday life.

For each tendency topic, tendency is divided into two through the primary indicator, and which is then further divided into two through the secondary indicator.

The generative AI application module 310 applies the data received from the small data coupling unit 200 to the generative AI to generate a plurality of questions for determining the primary indicator and a plurality of answers matched for each primary indicator for each of the four tendency topics of the relationship attitude, way of thinking, decision-making, and lifestyle, and generate a plurality of questions for determining the secondary indicator and a plurality of answers matched for each secondary indicator.

Referring to FIG. 4, finally, one question Q1 is asked to determine a primary indicator during a survey to a consumer, and three questions Q2-1 to Q2-3 are asked to determine a secondary indicator. The generative AI application module 310 generates a plurality of questions for determining the primary indicator and a plurality of answers matched for each primary indicator, generates a plurality of questions for determining the secondary indicator and a plurality of answers matched for each secondary indicator, and then finally selects an appropriate one among them.

The natural language processing module 320 removes the noise of the text generated through the generative AI application module 310. The natural language processing module 320 removes unnecessary spaces, special characters, spacing errors, etc. of text data, and consistently converts expressions within text data.

The image classification module 330 classifies an appropriate image among images generated through the generative AI application module. The image classification module 330 removes an image having a degree of conformity of 80% or less. The degree of conformity of 80% is an example.

The data verification module 340 verifies the text from which the noise is removed and the classified image. The data verification module 340 checks the missing value in the text generated through the generative AI and supplements missing information. It also checks for and corrects contextual errors in the text data.

The data verification module 340 verifies the degree of conformity to the criteria set for the image generated through the generative AI, evaluates the quality of the resolution, sharpness, noise, and the like of the image, and checks how much the image data is related to the text data to remove the image having the degree of conformity less than or equal to a reference value.

The customized consumer typing module generation unit 400 generates the final typing module 500 composed of a question and answer set for classifying the inner tendency of the consumer corresponding to the inputted topic according to the four tendency topics of relationship attitude, way of thinking, decision-making, and lifestyle using the verified text and image set.

The customized consumer typing module generation unit 400 generates the final typing module 500, which classifies consumers into a total of 256 types, by generating a single question for determining a primary indicator and an answer matched for each primary indicator and generating a plurality of questions for determining a secondary indicator and an answer matched for each secondary indicator for each of the four tendency topics of relationship attitude, way of thinking, decision-making, and lifestyle. The final survey dataset (text, image) generated through the final typing module 500 is output to the user UI of the client company.

### Consumer inner tendency typing analysis model production method using generative AI

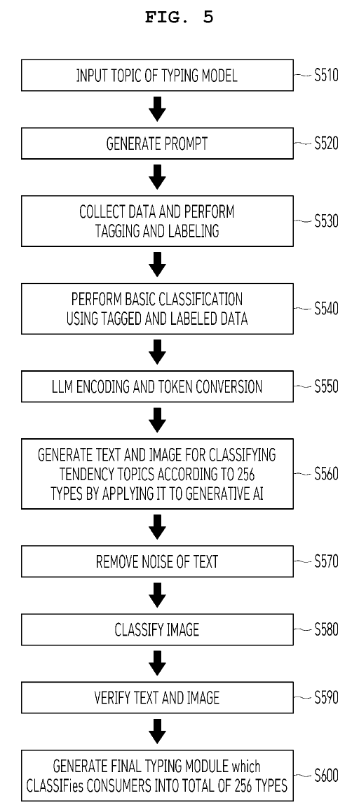

Referring to FIG. 5, a consumer inner tendency typing analysis model production method using generative AI will be described. Detailed descriptions of parts overlapping with the above description will be omitted.

First step S510: A topic of a typing model suitable for a consumer of a client company is input.

Second step S520: A prompt associated with the four tendency topics of relationship attitude, way of thinking, decision-making, and lifestyle capable of identifying the inner tendency of the consumer for the inputted topic is generated.

Third step S530: Data is collected using the prompt generated by a prompt optimization module, and tagging and labeling are performed on the collected data.

Fourth step S540: Tagged, labeled data is classified into up to 16 types according to a primary indicator based on four tendency topics of relationship attitude, way of thinking, decision-making, and lifestyle, and further classified into up to 16 types according to a secondary indicator, and the consumer group is basically classified into a total of 256 types.

Fifth step S550: LLM encoding and token conversion are processed for communication with the generative AI.

Sixth step S560: A received token is applied to the generative AI to expand a dataset of a typing module by additionally generating or modifying text and images for classifying the inner tendency of the customer into a total of 256 types according to types based on the four tendency topics of relationship attitude, way of thinking, decision-making, and lifestyle.

Seventh step S570: Noise of the text generated through the generative AI is removed.

Eighth step S580: An appropriate image among images generated through the generative AI is classified.

Ninth step S590: The text from which the noise is removed and the classified image are verified.

Tenth step S600: A final typing module, which classifies consumers into a total of 256 types, is generated by generating a single question for determining a primary indicator and an answer matched for each primary indicator and generating a plurality of questions for a secondary question and an answer matched for each secondary indicator, for each of the four tendency topics of relationship attitude, way of thinking, decision-making, and lifestyle by using verified data.

The fourth step may be configured as follows.

Tagged, labeled data is applied to the primary indicator learning module to determine the primary indicator for each of the four tendency topics.

In addition, the tagged, labeled data and the primary indicator determined by a primary indicator determination module are applied to a secondary indicator learning module to determine the secondary indicator for each of the four tendency topics.

Summarizing the above, it is possible to integrate generative AI with a typing model that can analyze consumer behavior data and inner tendency to quickly introduce the typing model to various industrial fields as follows.

### E-commerce/travel

1. Recommend customized product and content

2. Recommend customized products and content to individuals based on past purchase history, search history, browsing behavior, and inner tendencies

3. Subdivide customers based on their gender, age, income, lifestyle, etc., and establish customized marketing strategies for each subdivided customer

### Medical and learning services

1. Provide customized health care programs tailored to customer's tendency by coupling with personal health data

2. Identify learners' learning styles and levels to provide personalized learning content

3. Provide customized job recommendation and career search solutions by identifying student or user's inner tendencies

### Human resource management

1. Select appropriate talent by identifying competency and tendency of recruitment candidate

2. Identify employees' strengths and weaknesses to provide customized education and programs

### Financial service

1. Recommend customized financial products based on individual financial situation and investment tendency

### Government and non-profit organizations

1. Establish customized policies and provide social services through type classification

According to the present invention having the above-described configuration, when only the topic of the typing model suitable for the consumer of the client company is input, the prompt is optimized, data is automatically collected through the optimized prompt, and the collected data is coupled with the typing model which classifies inner tendency of the customer into a total of 256 types based on four tendency topics of relationship attitude, way of thinking, decision-making, and lifestyle and applied to the generative AI, thereby automatically and quickly creating a customized consumer typing module suitable for the customer.

Although the present invention has been described in detail with reference to preferred embodiments so far, those skilled in the art to which the present invention pertains may implement the present invention in other specific forms without changing the technical spirit or essential features thereof. Therefore, it should be understood that the embodiments described above are illustrative in all aspects and not restrictive.

In addition, the scope of the present invention is specified by the claims described below rather than the detailed description above, and it should be construed that all changes or modified forms derived from the meaning and scope of the claims and equivalent concepts thereof are included in the scope of the present invention.

What is claimed is:

1. A consumer inner tendency typing analysis model production system using generative AI, comprising:
a consumer typing topic input unit that inputs a topic of a typing model suitable for a consumer of a client company;
a small data coupling unit that collects and preprocesses data corresponding to the inputted topic of the typing model, and couples the data with a typing model that classifies inner tendency of the consumer for the topic of the typing model according to types based on four tendency topics of relationship attitude, way of thinking, decision-making, and lifestyle to prepare for input into a generative AI;
a type data generation unit that generates and verifies a text and image set for consumer type classification by applying the data received from the small data coupling unit to the generative AI; and
a customized consumer typing model generation unit that generates a final typing module composed of a question and answer set for classifying the inner tendency of the consumer corresponding to the inputted topic according to the four tendency topics of relationship attitude, way of thinking, decision-making, and lifestyle using the verified text and image set.

2. The consumer inner tendency typing analysis model production system of claim 1, wherein the small data coupling unit includes:
a prompt optimization module that generates a prompt associated with the four tendency topics of relationship attitude, way of thinking, decision-making, and lifestyle capable of identifying the inner tendency of the consumer for the inputted topic;
a data preprocessing module that collects data using the prompt generated by the prompt optimization module and performs tagging and labeling on the collected data;
a basic typing module that couples the tagged, labeled data with a typing module for classifying the inner tendency of the consumer into 256 types according to types based on the four tendency topics of relationship attitude, way of thinking, decision-making, and lifestyle; and
an encoding/token conversion module that processes LLM encoding and token conversion for communication with the generative AI.

3. The consumer inner tendency typing analysis model production system of claim 2, wherein the prompt optimization module is applied with a method of analyzing topics and prompt patterns of an existing generated prompt database using an artificial intelligence neural network-based algorithm and automatically generating a prompt suitable for the input topic.

4. The consumer inner tendency typing analysis model production system of claim 2, wherein the basic typing module classifies tagged, labeled data are into up to 16 types according to a primary indicator based on the four tendency topics of the relationship attitude, way of thinking, decision-making, and lifestyle, and further classifies the tagged, labeled data into up to 16 types according to a secondary indicator to thereby classify a consumer group into a total of 256 types.

5. The consumer inner tendency typing analysis model production system of claim 2, wherein the basic typing module includes:
a primary indicator module that types consumer tendency into two primary indicators for each tendency topic for the four tendency topics;
a secondary indicator module that types the primary indicator into two secondary indicators according to the consumer tendency;
a primary indicator determination module that determines the primary indicator for each of the four tendency topics by substituting the data tagged and labeled by the data preprocessing module into the primary indicator module;
a secondary indicator determination module that determines the secondary indicator for each of the four tendency topics by substituting the data tagged and labeled by the data preprocessing module into the secondary indicator module; and
a basic typing result output module that outputs a basic typing result by reflecting the determinations of the primary indicator and the secondary indicator.

6. The consumer inner tendency typing analysis model production system of claim 5, wherein the basic typing module further includes:
a primary indicator learning module that trains the primary indicator for each of the four tendency topics by applying tagged and labeled training data to a supervised learning-based machine learning engine; and
a secondary indicator learning module that trains the secondary indicator for each of the four tendency topics by applying the tagged and labeled training data and the primary indicator to the supervised learning-based machine learning engine, and
the primary indicator determination module determines the primary indicator for each of the four tendency topics by applying the data tagged and labeled by the data preprocessing module to the primary indicator learning module, and
the secondary indicator determination module determines the secondary indicator for each of the four tendency topics by applying the data tagged and labeled by the data preprocessing module and the primary indicator determined by the primary indicator determination module to the secondary indicator learning module.

7. The consumer inner tendency typing analysis model production system of claim 1, wherein the type data generation unit includes:
a generative AI application module that applies data received from the small data coupling unit to the generative AI to expand a dataset of a typing module by additionally generating or modifying text and images for classifying the inner tendency of the customer into a total of 256 types according to types based on the four tendency topics of relationship attitude, way of thinking, decision-making, and lifestyle;
a natural language processing module that removes noise of the text generated through a generative AI application module;
an image classification module that classifies an appropriate image among images generated through the generative AI application module; and
a data verification module that verifies the text from which the noise is removed and the classified image.

8. The consumer inner tendency typing analysis model production system of claim 7, wherein the generative type AI application module applies the data received from the small data coupling unit to the generative AI to generate a plurality of questions for determining a primary indicator and a plurality of answers matched for each primary indicator for each of four tendency topics of relationship attitude, way of thinking, decision-making, and lifestyle, and generate a plurality of questions for determining a secondary indicator and a plurality of answers matched for each secondary indicator.

9. The consumer inner tendency typing analysis model production system of claim 1, wherein the customized consumer typing module generation unit generates a final typing module, which classifies consumers into 256 types by generating a single question for determining a primary indicator and an answer matched for each primary indicator and generating a plurality of questions for a secondary question and an answer matched for each secondary indicator for each of the four tendency topics of relationship attitude, way of thinking, decision-making, and lifestyle by using verified data received from the type data generation unit.

10. A consumer inner tendency typing analysis model production method using generative AI, comprising:
a first step of inputting a topic of a typing model suitable for a consumer of a client company;
a second step of generating a prompt associated with the four tendency topics of relationship attitude, way of thinking, decision-making, and lifestyle capable of identifying the inner tendency of the consumer for the inputted topic;
a third step of collecting data using the prompt generated by the prompt optimization module and performing tagging and labeling on the collected data;
a fourth step of classifying tagged, labeled data into up to 16 types according to a primary indicator based on the four tendency topics of the relationship attitude, way of thinking, decision-making, and lifestyle, and further classifying the tagged, labeled data into up to 16 types according to a secondary indicator to basically classify a consumer group into a total of 256 types;
a fifth step of processing LLM encoding and token conversion for communication with the generative AI;
a sixth step of applying a received token to the generative AI to expand a dataset of a typing module by additionally generating or modifying text and images for classifying the inner tendency of the customer into a total of 256 types according to types based on the four tendency topics of relationship attitude, way of thinking, decision-making, and lifestyle;
a seventh step of removing noise of the text generated through a generative AI;
an eighth step of classifying an appropriate image among images generated through the generative AI;
a ninth step of verifying the text from which the noise is removed and the classified image, and
a tenth step of generating a final typing module, which classifies consumers into 256 types by generating a single question for determining a primary indicator and an answer matched for each primary indicator and generating a plurality of questions for a secondary question and an answer matched for each secondary indicator, for each of the four tendency topics of relationship attitude, way of thinking, decision-making, and lifestyle by using verified data.

11. The consumer inner tendency typing analysis model production method of claim 10, wherein, in the fourth step, tagged, labeled data is applied to a primary indicator learning module to determine the primary indicator for each of the four tendency topics, and the tagged, labeled data and the primary indicator determined by the primary indicator determination module are applied to a secondary indicator learning module to determine a secondary indicator for each of the four tendency topics.
